(19) United States
(12) Patent Application Publication
(10) Pub. No.: US 2026/0213218 A1
(43) Pub. Date: Jul. 23, 2026

(54) BATTERY CELL WITH REDUCED FORMATION OF INACTIVE LITHIUM

(71) Applicant: GM GLOBAL TECHNOLOGY OPERATIONS LLC, Detroit, MI (US)

(72) Inventors: Xin ZHANG, Shanghai (CN); Qili SU, Shanghai (CN); Haijing LIU, Shanghai (CN)

(21) Appl. No.: 19/047,365

(22) Filed: Feb. 6, 2025

(30) Foreign Application Priority Data
Jan. 21, 2025 (CN) 2025100958983

(51) Int. Cl. H01M 4/74; H01M 4/02; H01M 4/58; H01M 4/62; H01M 4/66; H01M 4/76; H01M 50/446; H01M 50/491

(52) U.S. Cl. CPC H01M 4/742; H01M 4/5825; H01M 4/623; H01M 4/625; H01M 4/661; H01M 4/669; H01M 4/762; H01M 50/446; H01M 50/491; H01M 2004/021

(57) ABSTRACT

A battery cell includes C cathode electrodes each including a cathode active material layer and a cathode current collector, A anode electrodes each including an anode active material layer and an anode current collector, and S separators, where C, A, and S are integers greater than one. An interlayer is arranged between each of the S separators and the cathode active material layer of each of the C cathode electrodes. The interlayer includes a porous conductive network including one of a wire mesh layer and a perforated metal layer.

### CROSS-REFERENCE TO RELATED APPLICATIONS

This application claims the benefit of Chinese Patent Application No. 202510095898.3 filed on Jan. 21, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a battery cell with reduced formation of inactive lithium.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes each including a cathode active material layer and a cathode current collector, A anode electrodes each including an anode active material layer and an anode current collector, and S separators, where C, A, and S are integers greater than one. An interlayer is arranged between each of the S separators and the cathode active material layer of each of the C cathode electrodes. The interlayer includes a porous conductive network including one of a wire mesh layer and a perforated metal layer.

In other features, a porosity of the porous conductive network is greater than 40%. A thickness of the porous conductive network is in a range from 5 to 100 μm. The one of the wire mesh layer and the perforated metal layer is made of a material selected from a group consisting of copper, stainless steel, and gold. The cathode active material layer comprises cathode active material in a range from 30 to 98 wt %. The cathode active material layer includes a cathode active material is selected from a group consisting of a layered oxide, an olivine-type oxide, a monoclinic-type oxide, a spinel-type oxide, and lithium sulfide (Li₂S), where M is a transition metal.

In other features, the cathode active material layer includes at least one of a conductive additive in a range from 1 to 30 wt %, and a binder in a range from 1 to 20 wt %. The conductive additive is selected from a group consisting of carbon black, graphite, graphene, graphene oxide, Super P, acetylene black, carbon nanofibers, and carbon nanotubes. The binder is selected from a group consisting of poly(vinylidene fluoride) (PVDF), poly(vinylidene fluoride-cohexafluoropropylene) (PVDF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

In other features, each of the S separators has a porosity in a range from 5 to 100%. Each of the S separators has a porosity in a range from 85 to 95%. Each of the S separators is selected from a group consisting of a polyolefin-based separator, a ceramic-coated separator, a polymer-coated separator, a composite-coated separator, a cellulose separator, a glass fiber membrane, and a porous polyimide membrane.

A battery cell includes C cathode electrodes each including a cathode active material layer and a cathode current collector, A anode electrodes each including an anode active material layer and an anode current collector, S separators, where C, A, and S are integers greater than one. An interlayer arranged between each of the S separators and the cathode active material layer of each of the C cathode electrodes. The interlayer includes a porous conductive network including one of a wire mesh layer and a perforated metal layer. A porosity of the porous conductive network is greater than 40%, a thickness of the porous conductive network is in a range from 5 μm to 100 μm, and the one of the wire mesh layer and the perforated metal layer is made of a material selected from a group consisting of copper, stainless steel, and gold.

In other features, the cathode active material layer comprises a cathode active material in a range from 30 to 98 wt %. The cathode active material layer includes a cathode active material selected from a group consisting of a layered oxide, an olivine-type oxide, a monoclinic-type oxide, a spinel-type oxide, and lithium sulfide (Li₂S), where M is a transition metal. The cathode active material layer includes at least one of a conductive additive in a range from 1 to 30 wt %, and a binder in a range from 1 to 20 wt %.

In other features, the conductive additive is selected from a group consisting of carbon black, graphite, graphene, graphene oxide, Super P, acetylene black, carbon nanofibers, and carbon nanotubes. The binder is selected from a group consisting of poly(vinylidene fluoride) (PVDF), poly(vinylidene fluoride-cohexafluoropropylene) (PVDF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

In other features, each of the S separators has a porosity in a range from 5 to 100%. Each the S separators is selected from a group consisting of a polyolefin-based separator, a ceramic-coated separator, a polymer-coated separator, a composite-coated separator, a cellulose separator, a glass fiber membrane, and a porous polyimide membrane.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery cell including anode electrodes, cathode electrodes, and separators;

FIGS. 2A to 2C are side cross sections of an example of an anode electrode during cycling and formation of inactive lithium;

FIG. 3 is a side cross section of an example of a battery cell including an interlayer including a porous conductive network arranged between the anode active material layer and the separator according to the present disclosure;

FIGS. 4A and 4B are plan and cross sectional views of an example of a wire mesh layer of the porous conductive network according to the present disclosure;

FIGS. 5A and 5B are plan and cross sectional views of an example of a perforated metal layer of the porous conductive network according to the present disclosure;

FIGS. 6A to 6C are side cross sections of an example of an anode electrode and the interlayer during cycling according to the present disclosure; and

FIG. 7 is a graph illustrating an example of capacity retention as a function of cycles for example battery cells without the interlayer and with the interlayer according to the present disclosure.

In the drawings, reference numbers may be reused to identify similar and/or identical elements.

### DETAILED DESCRIPTION

While the battery cells are described below in the context of vehicles, the battery cells can be used in other mobile or stationary applications.

Lithium is an excellent active material for anode electrodes of next-generation rechargeable batteries. Lithium has a high theoretical specific capacity (3860 mAh/g), a low density (0.534 g/cm³), and a low electrochemical potential (3.040V). However, inactive lithium formed during cycling eventually causes capacity loss and other problems. Inactive or “dead” lithium includes electrically isolated, unreacted metallic lithium formed during cycling. The formation of the inactive lithium causes active material loss and capacity degradation. Moreover, the size of the inactive lithium is generally at the micron level, which can lead to other problems.

A battery cell according to the present disclosure includes an interlayer including a porous conductive network arranged between the anode active material layer and the separator layer. In some examples, the porous conductive network activates the electrically isolated lithium by providing a conductive path to the anode active material layer to prevent formation of inactive lithium. Reducing the inactive lithium improves performance and prolongs the life of the battery cell.

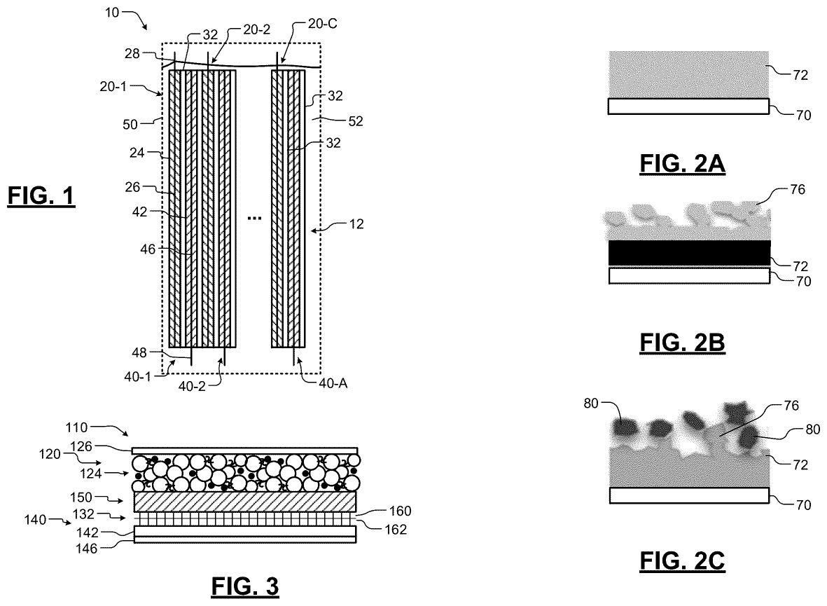

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Liquid electrolyte 52 is added to the enclosure 50.

The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46. During charging/discharging, the A anode electrodes 40 and the C cathode electrodes 20 exchange lithium ions. In some examples, the cathode active material layers 24 and/or the anode active material layers 42 comprise coatings including one or more active materials, one or more conductive additives, and/or one or more binder materials that are applied to the current collectors. In other examples, the anode active material layers include a metal layer such as a lithium layer formed on the anode current collector.

In some examples, the cathode current collector 26 and/or the anode current collector 46 comprise metal foil, metal mesh, perforated metal layer, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2A to 2C, an anode electrode includes an anode current collector 70 and an anode active material layer 72 (e.g., lithium metal). In FIG. 2B, the anode electrode is shown after random electroplating by lithium particles 78 during cycling. Some of the lithium particles 78 become electrically isolated and form inactive lithium particles 80 causing active material loss and capacity degradation.

Referring now to FIG. 3, a battery cell 110 includes a cathode electrode 120 including a cathode active material layer 124 and a cathode current collector 126. The battery cell 110 includes a separator 132 and an anode electrode 140 including an anode active material layer 144 and an anode current collector 146.

An interlayer 150 is arranged between the anode active material layer 144 and the separator 132. The interlayer 150 includes a porous conductive network 160 (immersed in liquid electrolyte 162). The porous conductive network 160 provides electron transmission channels that connect to the lithium particles (separated from the lithium metal of the anode electrode) to the lithium metal of the anode electrode.

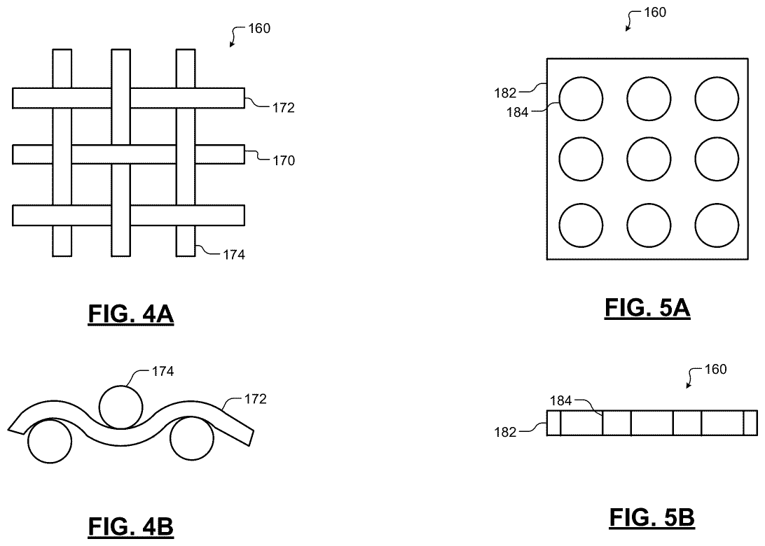

Referring now to FIGS. 4A to 5B, examples of the porous conductive network are shown. In FIGS. 4A and 4B, the porous conductive network 160 includes a wire mesh layer 170 including a plurality of first wires 172 and a plurality of second wires 174 that are interwoven. In other words, the plurality of first wires 172 pass over and under the plurality of second wires 174 (and vice versa). In FIGS. 5A and 5B, the porous conductive network 160 includes a perforated metal layer 180 including a plurality of holes 184.

In some examples, the interlayer 160 has a thickness in a range from 5 μm to 100 μm. In some examples, the interlayer 160 has a thickness of 10 μm for 1 mAh/cm² lithium anode. In some examples, the porous conductive network 160 is selected from a group consisting of copper, stainless steel, gold, or other metals that do not react with lithium metal. In some examples, a porosity of the porous conductive network 160 is greater than 40%. In some examples, the porous conductive network 160 is interconnected.

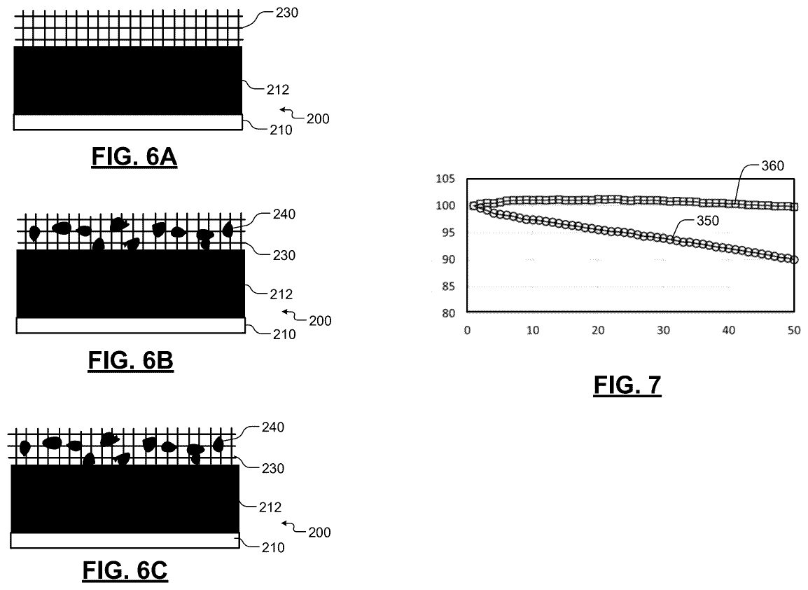

Referring now to FIGS. 6A to 6C, an anode electrode 200 including an anode current collector 210 and an anode active material layer 212 including lithium metal is shown. In FIG. 6B, the anode electrode 200 is shown after random electroplating by lithium particles 220. Instead of becoming inactive lithium, the wire mesh layer or the perforated metal layer of a porous conductive network 230 provides a connection to prevent isolation of the lithium particles and significantly reduce active material loss and capacity degradation as shown in FIG. 6C.

Referring now to FIG. 7, a graph illustrates an example of capacity retention as a function of cycles for example battery cells without the interlayer at 350 and with the interlayer at 360. The battery cells without the interlayer at 350 show significant loss of capacity retention after about 250 to 300 cycles. The battery cells with the interlayer at 314 do not show significant loss of capacity retention.

In some examples, the cathode active material layer comprises cathode active material in a range from 30 to 98 wt %, an optional conductive additive in a range from 1 to 30 wt %, and an optional binder in a range from 1 to 20 wt %. In some examples, the cathode active material is selected from a group consisting of a layered oxide (e.g., LiMO₂), an olivine-type oxide (e.g., LiMPO₄), a monoclinic-type oxide (e.g., Li₃M₂(PO₄), a spinel-type oxide (e.g., LiM₂O₄), where M is a transition metal (e.g., cobalt (Co), nickel (Ni), manganese (Mn), iron (Fe), aluminum (Al), V, or a combination thereof), and lithium sulfide (Li₂S).

In some examples, the conductive additive is selected from a group consisting of carbon black, graphite, graphene, graphene oxide, Super P, acetylene black, carbon nanofibers, carbon nanotubes, and other electronically conductive additives. In some examples, the binder is selected from a group consisting of poly(vinylidene fluoride) (PVDF), poly(vinylidene fluoride-cohexafluoropropylene), (PVDF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

In some examples, the separator has a porosity in a range from 5 to 100%. In some examples, the porosity is in a range from 85% to 95% (e.g., 90%). In some examples, the separator is selected from a group consisting of a polyolefin-based separator, a ceramic-coated separator, a polymer-coated separator, a composite-coated separator, a cellulose separator, a glass fiber membrane, and a porous polyimide membrane. Examples of polyolefin-based separators include: polypropylene (PP), polyethylene (PE), a dual layer type such as PP-PE, and a three-layer type such as PP-PE-PP. Examples of ceramic-coated separators include silicon dioxide (SiO₂)-coated PE and alumina (Al₂O₃)-coated PE. Examples of the polymer-coated separators include polyvinylidene fluoride (PVDF)-coated PE and aramid-coated PE. Examples of composite coated separators include PVDF and Al₂O₃-coated PE and poly(methyl methacrylate) (PMMA) and Al₂O₃ coated PE. In some examples, the thickness of the separator is greater than 15 μm to lower the risk of short circuits.

In some examples, the anode active material is selected from a group consisting of metallic lithium, carbonaceous materials (e.g., graphite, hard carbon, soft carbon etc.), silicon, silicon mixed with graphite, a transition metal (e.g., tin (Sn)), a metal oxide/sulfide (e.g., TiO₂, FeS), and other lithium-accepting anode materials.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
C cathode electrodes each including a cathode active material layer and a cathode current collector;
A anode electrodes each including an anode active material layer and an anode current collector;
S separators, where C, A, and S are integers greater than one; and
an interlayer arranged between each of the S separators and the cathode active material layer of each of the C cathode electrodes,
wherein the interlayer includes a porous conductive network including one of a wire mesh layer and a perforated metal layer.

2. The battery cell of claim 1, wherein a porosity of the porous conductive network is greater than 40%.

3. The battery cell of claim 1, wherein a thickness of the porous conductive network is in a range from 5 to 100 μm.

4. The battery cell of claim 1, wherein the one of the wire mesh layer and the perforated metal layer is made of a material selected from a group consisting of copper, stainless steel, and gold.

5. The battery cell of claim 1, wherein the cathode active material layer comprises cathode active material in a range from 30 to 98 wt %.

6. The battery cell of claim 1, wherein the cathode active material layer includes a cathode active material is selected from a group consisting of a layered oxide, an olivine-type oxide, a monoclinic-type oxide, a spinel-type oxide, and lithium sulfide (Li₂S), where M is a transition metal.

7. The battery cell of claim 1, wherein the cathode active material layer includes at least one of:
a conductive additive in a range from 1 to 30 wt %, and
a binder in a range from 1 to 20 wt %.

8. The battery cell of claim 7, wherein the conductive additive is selected from a group consisting of carbon black, graphite, graphene, graphene oxide, Super P, acetylene black, carbon nanofibers, and carbon nanotubes.

9. The battery cell of claim 7, wherein the binder is selected from a group consisting of poly(vinylidene fluoride) (PVDF), poly(vinylidene fluoride-cohexafluoropropylene) (PVDF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

10. The battery cell of claim 1, wherein each of the S separators has a porosity in a range from 5 to 100%.

11. The battery cell of claim 1, wherein each of the S separators has a porosity in a range from 85 to 95%.

12. The battery cell of claim 11, wherein each the S separators is selected from a group consisting of a polyolefin-based separator, a ceramic-coated separator, a polymer-coated separator, a composite-coated separator, a cellulose separator, a glass fiber membrane, and a porous polyimide membrane.

13. A battery cell comprising:
C cathode electrodes each including a cathode active material layer and a cathode current collector;
A anode electrodes each including an anode active material layer and an anode current collector;
S separators, where C, A, and S are integers greater than one; and
an interlayer arranged between each of the S separators and the cathode active material layer of each of the C cathode electrodes,
wherein the interlayer includes a porous conductive network including one of a wire mesh layer and a perforated metal layer,
wherein a porosity of the porous conductive network is greater than 40%, a thickness of the porous conductive network is in a range from 5 μm to 100 μm, and the one of the wire mesh layer and the perforated metal layer is made of a material selected from a group consisting of copper, stainless steel, and gold.

14. The battery cell of claim 13, wherein the cathode active material layer comprises a cathode active material in a range from 30 to 98 wt %.

15. The battery cell of claim 13, wherein the cathode active material layer includes a cathode active material selected from a group consisting of a layered oxide, an olivine-type oxide, a monoclinic-type oxide, a spinel-type oxide, and lithium sulfide (Li₂S), where M is a transition metal.

16. The battery cell of claim 15, wherein the cathode active material layer includes at least one of:
a conductive additive in a range from 1 to 30 wt %, and
a binder in a range from 1 to 20 wt %.

17. The battery cell of claim 16, wherein the conductive additive is selected from a group consisting of carbon black, graphite, graphene, graphene oxide, Super P, acetylene black, carbon nanofibers, and carbon nanotubes.

18. The battery cell of claim 16, wherein the binder is selected from a group consisting of poly(vinylidene fluoride) (PVDF), poly(vinylidene fluoride-cohexafluoropropylene) (PVDF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

19. The battery cell of claim 13, wherein each of the S separators has a porosity in a range from 5 to 100%.

20. The battery cell of claim 19, wherein each the S separators is selected from a group consisting of a polyolefin-based separator, a ceramic-coated separator, a polymer-coated separator, a composite-coated separator, a cellulose separator, a glass fiber membrane, and a porous polyimide membrane.
